(19) United States
(12) Patent Application Publication
(10) Pub. No.: US 2008/0171304 A1
(43) Pub. Date: Jul. 17, 2008

(54) DENTAL IMPLANT KIT AND METHOD OF USING SAME

(76) Inventors: William J. McGinnis, Cincinnati, OH (US); Scott A. Metrick, Glenview, IL (US)

Correspondence Address: LADAS & PARRY LLP, 224 SOUTH MICHIGAN AVENUE, SUITE 1600, CHICAGO, IL, 60604, US

(21) Appl. No.: 11/622,213

(22) Filed: Jan. 11, 2007

(51) Int. Cl. A61C 8/00

(52) U.S. Cl. 433/173; 206/572

(57) ABSTRACT

Dental implant kits and methods of installing the dental implant kit into a bone are provided. The kits and methods make us of a housing understructure having opposing electrodes for providing a therapeutic electrical signal across the electrodes in order to promote the health and accelerate the healing of the implanted housing understructure in bone. The dental implant kit also has a closure unit configured to be attached to the housing understructure that provides the electrical energy required to drive the therapeutic electrical signal. An optional abutment unit is also described that also provides the electrical energy to drive the therapeutic electrical signal. The method includes the steps of cementing, combining, cutting, extricating, installing, joining, linking, obtaining, opening, reaming, releasing, removing, sewing, and testing.

### FIELD OF THE INVENTION

The present invention relates to percutaneous prosthetic members for attachment of artificial eyes, noses, ears, limbs, and in particular, a dental implant kit and method of using same for providing a therapeutic electrical signal across opposing electrodes of the implant for use in stimulating good health and healing at the implant and bone interface.

### DESCRIPTION OF THE PRIOR ART

Regretfully, a relatively large number of people have to endure the physical and mental hardships experienced with the loose of a tooth. Tooth loss may be due to disease or injury and is often desirable to avoid any further physical and mental harm by installing some form of an artificial tooth. Accordingly, various techniques have been developed to replace lost teeth. In situations where there are sufficient teeth adjacent the void from the lost tooth, a bridge technique is often used to structurally buttress an prosthetic tooth mounted within the void. In situations where there is insufficient natural teeth remaining to support and stabilize the bridge, a denture may be the only practical solution for the patient. In yet other instances, a dental implant may be installed within the void.

The morphology of any tooth varies in accordance with its position and function, however all teeth share certain common physiological and morphological traits. As depicted in FIG. 1, a tooth 10 generally comprises a central pulp 30 surrounded by a calcareous substance known as dentin 65. The central pulp 30 is kept alive by its connection to underlying arteries 40, veins 50, and nerves 60.

As also depicted in FIG. 1, the tooth projects outwardly from sockets 70 (also known as alveoli dentalis) within the alveolar bone 120 of the maxillac (upper jawbone 160) or mandible (lower jawbone 160).

Each socket 70 is a void or a depression within the alveolar bone 120 of the jawbone 200 in which each socket 70 is lined by connective tissue known as the periodontal membrane 80. The root(s) 90 of the tooth 10 are the portion of the tooth 10 that actually fit within the socket 70.

Each root 90 is affixed to the periodontal membrane 80 and held in place within the socket 70 by a calcified connective tissue known as the cementum 100. One of the functions of this periodontal membrane 80 is that it serves as a “shock absorber” during the mastication (chewing) process.

The crown 20, i.e., the projecting portion of a tooth 10, comprises grinding, cutting and/or exposed surfaces which are covered by yet another calcified connective tissue known as enamel 110. The gums 130, or gingival tissue, surround and cover the base of the crown 20 and project between adjacent surfaces of the teeth 10.

The gums 130, or gingival tissue serves to anchor teeth ill place, as illustrated in FIG. 2.

Bacteria, called plaque, can result in inflammation or infection of the gums 130 that often results in gum disease, or periodontal disease. The plaque bacteria produce a sticky film on teeth 10 and over time, the plaque hardens into calculus (tartar). Gingivitis, a mild inflammation, characterized by swollen and bleeding gums 130, is primarily caused by poor oral. Gingivitis disease is reversible with proper professional care and good oral home care.

If the gingivitis is left untreated, this disease spreads to other supporting structures including alveolar bone 120 which produce a more advanced stage of periodontal disease known as periodontitis. Poor hygiene including tobacco use, genetics, pregnancy, puberty, stress, medications, clenching or grinding of teeth, diabetes, and poor nutrition have been found to contribute the development and advancement of periodontal disease. As depicted in FIG. 3, periodontitis results in the permanent damage to the alveolar bone 120 and the periodontal membrane 80. Periodontitis is identified by its characteristic receding of gums 130 where the gums 130 no longer envelop around the teeth. This receding of gums 130 results in the formation of pockets or empty chambers where food and other debris may collect between the teeth and gums 130. As the periodontitis disease progresses, the damage to the alveolar bone results in teeth becoming loose. Regretfully, to prevent any further damage from the progression of the periodontitis disease extraction of the loose teeth is often necessitated. Therefore, periodontal disease is a major cause of tooth loss.

Because of the widespread nature of the disease, there have been a variety of methods devised to implant and secure a dental prosthesis.

Inserting a screw or similar type of device within the jawbone 200 to serve as an artificial root structure is a common type of implant known as endosseous. The implant also protrudes through the gum in order to provide a means for holding the prosthesis. The problem with endosseous is that a sufficient amount of jawbone 200 is needed to assure a sound structural foundation. When insufficient amounts of jawbone 200 are present then an endosteal implant is not possible due to minimal bone height. In this case, a metal framework's posts protruding through the gum to hold the prosthesis can be mounted on top of the jawbone 200 to provide a subperiosteal implant.

A conventional prior art endosteal implant system 140, depicted in FIG. 4, typically comprises an implant 150, an insertion tool 160, a closure shank 170, and an abutment adaptor 180 adapted to receive a dental prosthesis 190.

Most of the conventional implants 150 are often cylindrically-shaped components that are made of rigid, non-expandable biocompatible materials, e g., a metallic alloy (e.g., titanium alloy) or a ceramic material (e.g., aluminum oxide, Al₂O₃). It is often preferable that the material permit osteo ingrowth (growth of bony tissue), also known as ankylosis, into the implant 150.

Accordingly, the implant 150 may be made of a porous hollow material or solid material. It is preferable that the materials of the implant 150 produce osseointegration of the fixture with the patient's jawbone 200. The porous hollow material of the implant 150 in particular encourages osteo ingrowth into the implant 150. In either the porous hollow material or the solid material of the implant 150, the top portion of the implant 150 is designed to protrude above the gum line and is designed to receive the closure shank 170 and the abutment adaptor 180. The solid material of the implant 150 itself may additionally contain pores 115 penetrating the wall of the implant 150 to further promote osteo ingrowth.

The insertion tool 160 is a simple mechanical device that is often configured to be adapted to couple both the implant 150 and the abutment adaptor 180. Accordingly, the insertion tool 160 often provides a convenient means for inserting of the implant 150 within the jawbone 200, as well as, a convenient means for mounting the abutment adaptor 180 into the inserted implant 150.

The closure shank 170 may be any type of shank-like component such as a threaded screw, a threaded bolt and even a simple cylinder, as long as, it is adapted to fit within the top portion of the implant 150. The closure shank 170 is usually a temporary component that serves to cover and protect the top portion of the implant 150 after the implant 150 is inserted into the jawbone 200 so that the jawbone 200 may heal onto implant 150 without sealing the top portion of the implant. After sufficient healing, the closure shank 170 is then removed from the inserted implant and the abutment adaptor 180 is then mounted onto the inserted implant 150.

The abutment adaptor 180 is configured to fit onto the top portion of the implant 150 in which the abutment adaptor 180 serves to permit attachment of a dental prosthesis 190.

In use, the system 150 is employed in a three-part procedure. In the first part, i.e., stage I, of the procedure, the site is prepared for the insertion of the implant 150 by conventional techniques.

During stage I, the dental implant 150 inserted into the patient's jawbone 200. The oral surgeon first accesses the patient's jawbone 200 through the patient's gum 130 tissue and subsequently removes any remnants of the lost tooth 10 that needs to be replaced. This access site where the implant 150 will be anchored is then widened by drilling and/or reaming to house the dental implant 150 to be inserted. The dental implant 150 is then inserted into the prepared hole 210 within the jawbone 200, typically by screwing, although other techniques are known for introducing the implant in the jawbone 200. Often times, the dental implant 150 includes a hollow threaded bore traversing through at least a portion of its body and extending out through its proximal end which is exposed through the crestal bone for receiving and supporting the final tooth prosthesis 190.

After the implant 150 is initially installed in the jawbone 200 a temporary closure shank 170 or healing cap (not shown), which is ordinarily made of a dental grade metal, is mounted onto the exposed proximal end of the installed implant 150 in order to seal an internal bore (not shown) of the implant 150. The closure shank 170 typically includes a threaded mating end, which can be mounted into the internal bore of the implant 150. After the closure shank 170 is secured in place over the installed implant, the gum 130 is sutured over the installed implant 150 with the attached closure shank 170 to allow the implantation site to heal and to allow desired osseointegration to occur. Usually complete osseointegration typically takes anywhere from four to ten months to occur, but stage II does not necessarily require that osseointegration to be complete.

As depicted in FIG. 5A, stage I includes the operation of installing the implant 150 into a prepared hole 210 (represented by phantom lines in FIGS. 5A-5D) within the jawbone 200. The mounting of the implant 150 into the prepared hole 210 of the jawbone 200 may be performed by using the insertion tool 160 to screw (represented by arrow in FIG. 5A) the implant 150 into the jawbone 200. As depicted in FIG. 5B, stage I also includes the operation of mounting the closure shank 170 onto the installed implant 150 which is shown screwed (represented by arrow in FIG. 5B) into the top portion of the implant 150. Finally, stage I of the procedure (not shown) is then complete when the surgeon sutures the gum over the installed implant 150 with the closure shank 170 mounted onto it.

After stage I is complete, a waiting period is imposed to allow healing for osteo (bone) ingrowth into and around the installed implant 150. The duration of this waiting period is desirable to last at least several weeks later and preferably last up to many months. It is worth noting that this healing does not reestablish the periodontal membrane/ligament that was destroyed as a result of the tooth loss. As a result this healed interface between the implant 150 and the Jawbone 170 may initially be healed as a relatively rigid interfacial structure yet after healing this interface is subject to physically being weakened because of the strong forces associated with mastication.

As depicted in FIG 5C, after the interface is healed during the waiting period, then stage III of the procedure may then be performed. During stage III) the installed implant 150 is then re-accessed by making an incision through the patient's gum 130 tissues. The closure shank 170 is subsequently removed from the installed implant 150 which results in exposing the proximal end of the installed implant 150. Then an abutment adaptor 180 is typically mounted onto the installed implant 150 for use in controlling the healing and growth of the patient's gum 130 tissue around the implant site.

Afterwards a mold is usually made of the implanted area to accurately record the position and orientation of the installed implant 150 and the mounted abutment adaptor 180. This mold is used to create a three dimensional model of the mouth and/or the implant site and to provide information needed to fabricate the cosmetic tooth prosthetic 190. The mold provides laboratory technicians with an exact model of the patient's mouth, including the orientation of the implant fixture relative to the surrounding teeth 10. Based on this model of the patient's mouth, the technician then constructs a final restoration of a cosmetic tooth prosthesis 190.

As depicted in FIG. 5D, stage III of the procedure involves fabrication and alignment of a cosmetic tooth prosthesis 190 onto the mounted abutment adaptor 180 which is attached to the installed implant 150. The final step in stage III of the restorative procedure is to either attach the cosmetic tooth prosthesis 190 to the abutment adaptor 180 or to remove the abutment adaptor 180 and replace the abutment adaptor with the cosmetic tooth prosthesis 190. The conventional dental prosthesis 190 may then be attached using conventional adhesive techniques.

There are several recurring problems or difficulties associated with the above procedure. First, the healing of installed implant 150 with the patient's jawbone 200 must be well integrated which means that a substantial waiting period of up to several months is required. Second, even thought interface between the implant 150 and the jawbone 170 may be initially well healed, it remains as a relatively rigid interfacial structure which subjects it to being compromised due to mastication forces. Third, this consequential weakening of the interface may lead to stress shielding of the surrounding bone. Stress shielding results in the bone tissue around this weakened interface to be resorbed by the body which further weakens the interface between the jawbone 200 and the installed implant 150. Stress shielding can result saucerization, otherwise known as bone die-back, which progresses around the upper portion of an otherwise healthy dental implant 150. The saucerization loss of bone can lead to destabilization and even loosening of the dental implant. Finally, once sufficient bone tissue has undergone resorption, portions of the implant 150 can become exposed, and this surface, which is typically textured to provide high surface area, is susceptible to infection.

Therefore, it would be advantageous to design a dental implant 150 that can provide a means for accelerating the healing process of the implant 150 into the bone during the long quiescent period, i.e., the period between the first two stages, in order to achieve a stable interface within a shorter quiescent time period. Furthermore, it would also be advantageous to design a dental implant 150 that can provide a means for promoting the health (i.e., preventive maintenance) of the implant 150 and bone interface by encouraging the repair of any consequential damage brought about by long term wear. Further, it would be advantageous to design a dental implant 150 that provides a means for stimulating the healing of a compromised or failed interface after destabilization and/or loosening of the dental implant 150 without resorting to removal of the entire dental implant 150.

### SUMMARY OF THE INVENTION

The present kit and method of using, according to the principles of the present invention, overcomes a number of the shortcomings of the prior art by providing a novel dental implant kit and method for use in dental implant kit. The kit includes a housing understructure and a closure unit configured to be attached to the housing understructure. The closure unit has an electrical power supply, at least two electrical contacts, and an electrical circuit in which the electrical contacts are configured to be coupled to electrodes of the understructure when the closure unit is attached to the housing understructure. Whereupon the electrical circuit of the closure unit is configured to be coupled to the electrodes so that the electrical circuit can control the electrical signal across the electrodes of the housing understructure. The method includes the steps of cementing, combining, cutting, extricating, installing, joining, linking, obtaining, opening, reaming, releasing, removing, sewing, and testing.

In view of the foregoing disadvantages inherent in the known type dental implant kits and methods of using same now present in the prior art, the present invention provides an improved dental implant kit, which will be described subsequently in great detail, is to provide a new and improved dental implant kit which is not anticipated, rendered obvious, suggested, or even implied by the prior art, either alone or in any combination thereof.

To attain this, the present invention essentially comprises a dental implant kit and method of installing the dental implant kit into a bone. The kits and methods make us of a housing understructure having opposing electrodes for providing a therapeutic electrical signal across the electrodes in order to promote the health and accelerate the healing of the implanted housing understructure in bone. The dental implant kit also has a closure unit configured to be attached to the housing understructure which provides the electrical energy required to drive the therapeutic electrical signal. An optional abutment unit is also described that also provides the electrical energy to drive the therapeutic electrical signal.

There has thus been outlined, rather broadly, the more important features of the invention in order that the detailed description thereof that follows may be better understood, and in order that the present contribution of the art may be better appreciated.

The invention may also include an optional abutment unit that also provides the electrical energy to drive the therapeutic electrical signal across the electrodes attached to the housing understructure.

Numerous aspects, features and advantages of the present invention will be readily apparent to those of ordinary skill in the art upon reading of the following detailed description of presently preferred, but nonetheless illustrative, embodiments of the present invention when taken in conjunction with the accompany drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an aspect of the present invention to provide a new and improved dental implant kit and method of using same that has many of the advantages of the prior dental implant kits and minimizing a number of their disadvantages.

It is another aspect of the present invention to provide a new and improved dental implant kit that may be easily and efficiently manufactured and marketed.

An even further aspect of the present invention is to provide a new and improved dental implant kit that has a low cost of manufacture with regard to both materials and labor, and which accordingly is then susceptible of low prices of sale to the consuming public, thereby making the dental implant kit economically available to the buying public.

Still another aspect of the present invention is to provide a dental implant kit that provides in the apparatuses and methods of the prior art some of the advantages thererof, while simultaneously overcoming some of the disadvantages normally associated therewith.

Even still another aspect of the present invention is to provide a dental implant kit comprising a housing understructure having at least two opposing electrodes; a closure unit having at least two electrical contacts and an electrical power supply in which the closure unit 250 is configured to be attached to the housing understructure 230 in such a manner so as to provide and control an electrical signal across the opposing electrodes.

Lastly, it is an aspect of the present invention to provide a new and improved method of using comprising the steps of cementing, combining, cutting, extricating, installing, joining, linking, obtaining, opening, reaming, releasing, removing, sewing, and testing.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other aspects of the invention, along with the various features of novelty that characterize the invention, are pointed out with particularity in the claims annexed to and forming a part of this disclosure. For a better understanding of the invention, its operating advantages and the specific aspects attained by its uses, reference should be had to the accompanying drawings and description matter in which there are illustrated preferred embodiments of the invention.

### BRIEF DESCRIPTION OF THE DRAWINGS

The invention will be better understood and aspects other than those set forth above will become apparent when consideration is given to the following detailed description thereof Such description makes reference to the annexed drawings wherein:

FIG. 1 is a sectional view of a normal human tooth;

FIG. 2 is a sectional view, with portions removed, of normal, healthy teeth and gums;

FIG. 3 is a view similar to that shown in FIG. 2 and further illustrating the effects of periodontitis on the teeth and gums;

FIG. 4 is an exploded perspective view of a prior art dental implant system;

FIG. 5A-5D are schematic perspective views of a lower human jawbone illustrating the use of components of the prior art system shown in FIG. 4

FIG. 6A-6B are a side view and a respective cross sectional side view of an embodiment of the housing understructure of the dental implant kit constructed in accordance with the principles of the present invention;

FIG. 7A-7B are a side view and a respective cross sectional side view of an embodiment of the closure unit of the dental implant kit constructed in accordance with the principles of the present invention;

FIG. 8A-8B are a side view and a respective cross sectional side view of an embodiment of the abutment unit of the dental implant kit constructed in accordance with the principles of the present invention;

FIG. 9 is an exploded perspective view of a dental implant kit of the present invention;

FIG. 10 is a stylized side perspective view of a portion of a lower human jawbone showing the insertion of the housing understructure of the dental implant kit into a reamed out cavity in the jawbone;

FIG. 11 is a view similar to FIG. 10 showing the housing understructure mounted within the jawbone;

FIG. 12 is a view similar to FIG. 11 showing the insertion of the closure unit of the dental implant kit into the housing understructure mounted within the jawbone;

FIG. 13 is a view similar to FIG. 11 showing the insertion of the abutment unit of the dental implant kit into the housing understructure mounted within the jawbone;

FIG. 14 is a view similar to FIG. 13 showing the abutment unit of the dental implant kit inserted into the housing understructure mounted within the jawbone; and

FIG. 15 is a view similar to FIG. 14 showing a dental prosthesis cemented onto a portion of the abutment unit of the dental implant kit when the abutment unit is inserted into the housing understructure mounted within the jawbone.

The same reference numerals refer to the same parts throughout the various figures.

### DETAILED DESCRIPTION OF THE PREFERRED EMBODIMENT

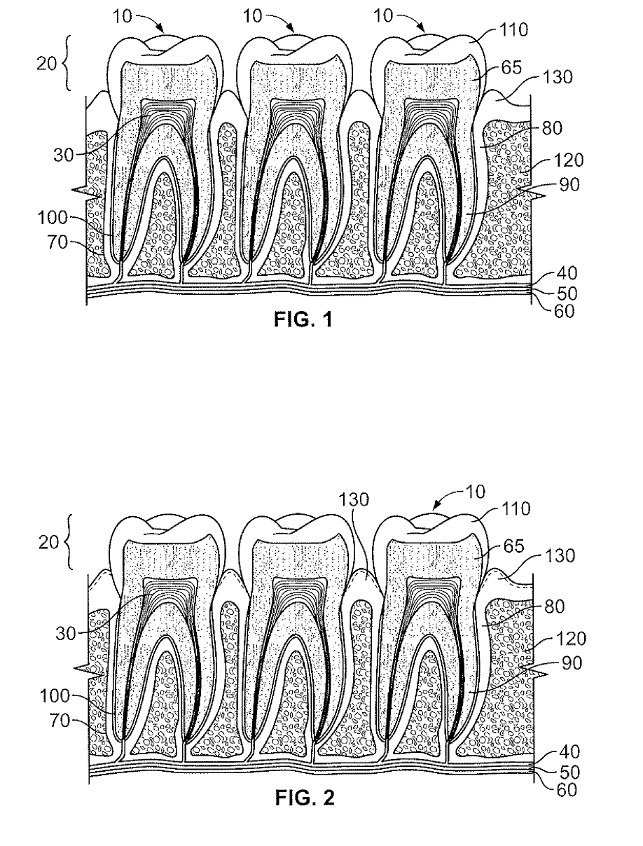

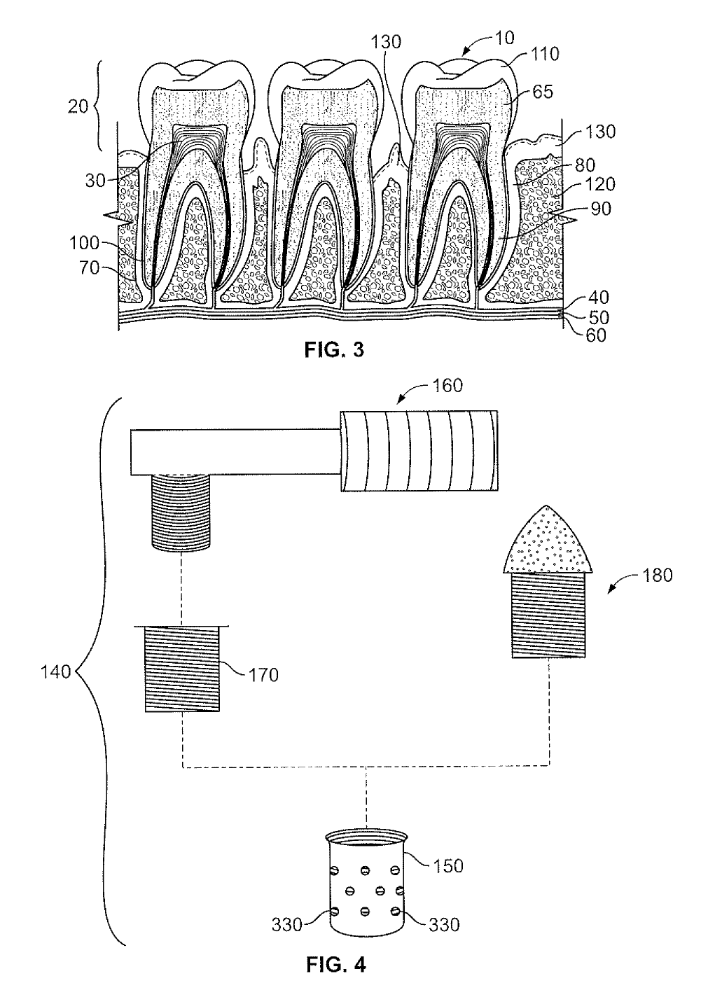

Referring now to the drawings, and in particular FIGS. 1 to 15 thereof, one preferred embodiment of the present invention is shown and generally designated by the reference numeral 220. One preferred embodiment of the dental implant kit 220 comprises a housing understructure 202; at least two opposing electrodes 204; a closure unit 206; and at least two electrical contacts 270. The opposing electrodes 240 are attached to the housing understructure 230 in which the electrodes 240 are electrically isolated from the housing understructure 230. The closure unit 250 is configured to be attached to the housing understructure 230. The electrical power supply 260 and the electrical contacts 270 are attached to the closure unit 250 in which the electrical power supply 260 and the electrical circuit 280 may be optionally hermetically sealed within the closure unit 250. The electrical circuit 280 is attached to the closure unit 250, in which the electrical circuit 280 is coupled to the electrical power supply 260 and coupled to the electrical contacts 270 when the closure unit 250 is attached to the housing understructure 230. Wherein the electrical contacts 270 are configured to be coupled to the electrodes 240 when the closure unit 250 is attached to the housing understructure 230 so that the electrical circuit 280 is configured to be coupled to the electrodes 240 when the closure unit 250 is attached to the housing understructure 230.

The electrical circuit 280 may be any known electronic circuit that is capable of influencing an electrical signal across the two electrodes 240 when the closure unit 250 is attached to the housing understructure 230. One optional configuration is that the electrical circuit 280 is configured to control an electrical current applied across the two electrodes 240 such as restricting the electrical current applied across the two electrodes 240 to no more than 20 milliamps. Alternately, the electrical circuit 280 may be optionally configured to control an electrical voltage applied across the two electrodes 240 such as restricting the electrical voltage applied across the two electrodes 240 to no more than 2 volts. Yet another possible electrical design of the electrical circuit 280 is that it may be optionally configured to control an time dependent electrical signal applied across the two electrodes 240 such as a pulse, square wave, triangular wave, sinusoidal wave function, etc., which influence either the applied current or the applied voltage across the two electrodes 240 when the closure unit 250 is attached to the housing understructure 230. The electrical power supply 260 of the closure unit 250 may be any commercially available power supply 260 such a battery power supply 260 and a high capacity capacitor power supply 260.

An optional abutment unit 290 may be added to the kit 220 in which the optional abutment unit 290 is configured to be attached to the housing understructure 230. The optional abutment unit 290 may be composed of any suitable material, such as a simple titanium metal alloy, or it may have an electrical power source 218; at least two electrical connects 220; and an electrical circuitry 320. The electrical power source 300 and the electrical connects 310 are attached to the abutment unit 290 in which the electrical power source 300 and the electrical circuitry 320 are optionally hermetically scaled within the abutment unit 290. The electrical circuitry 320 is attached to the abutment unit 290, in which the electrical circuitry 320 is coupled to the electrical power source 300 and coupled to the electrical connects 310. Wherein the electrical connects 310 are configured to be coupled to the electrodes 240 when the abutment unit 290 is attached to the housing understructure 230 so that the electrical circuitry 320 is configured to be coupled to the electrodes 240 when the abutment unit 290 is attached to the housing understructure 230.

The electrical circuitry 320 may be any known electronic circuit that is capable of influencing an electrical signal across the two electrodes 240 when the abutment unit 290 is attached to the housing understructure 230. One optional configuration is that the circuitry 320 is configured to control an electrical current applied across the two electrodes 240 such as restricting the electrical current applied across the two electrodes 240 to no more than 20 milliamps. Alternately, the electrical circuitry 320 may be optionally configured to control an electrical voltage applied across the two electrodes 240 such as restricting the electrical voltage applied across the two electrodes 240 to no more than 2 volts. Yet another possible electrical design of the circuitry 320 is that it may be optionally configured to control an time dependent electrical signal applied across the two electrodes 240 such as a pulse, square wave, triangular wave, sinusoidal wave function, etc., which influence either the applied current or the applied voltage across the two electrodes 240 when the abutment unit 290 is attached to the housing understructure 230. The optional electrical power source 300 of the optional abutment unit 290 may be any commercially available electrical power source 300 such as battery power source 300 and a high capacity capacitor power source 300.

An optional cosmetic dental prosthesis 190 may be added to the kit 220 in which the cosmetic dental prosthesis 190 is configured to be attached to the closure unit 250 or attached to the abutment unit 290.

An optional insertion tool 160 may be added to the kit 220 in which the optional insertion tool 160 is configured to hold the abutment unit 290.

The housing understructure 230 may be shaped and designed in any known geometric configuration. The housing understructure 230 may be made as a simple shank, a screw, a bolt, a cylinder, etc., as long as it is configured to be attached to the closure unit 250 or the abutment unit 290. One optional embodiment is that the housing understructure 230 has a plurality of pores 330 in the housing understructure 230 which is intended to encourage a well integrated interface between bone and the housing understructure.

Another preferred embodiment of the dental implant kit 220 comprises: a housing understructure 202; at least two opposing electrodes 204; a closure unit 206; an electrical power supply 208; at least two electrical contacts 210; an electrical circuit 212; an abutment unit 216; an electrical power source 218; at least two electrical connects 220; an electrical circuitry 320, a cosmetic dental prosthesis 214; and an insertion tool 160. The electrodes 240 are attached to the housing understructure 230. The closure unit 250 is configured to be attached to the housing understructure 230. The electrical power supply 260 and the electrical contacts 270 are attached to the closure unit 250. The electrical circuit 280 is attached to the closure unit 250, in which the the electrical circuit 280 is coupled to the electrical power supply 260 and coupled to the electrical contacts 270 wherein the electrical contacts 270 are configured to be coupled to the electrodes 240 when the closure unit 250 is attached to the housing understructure 230, whereby the electrical circuit 280 is configured to be coupled to the electrodes 240 when the closure unit 250 is attached to the housing understructure 230. The abutment unit 290 is configured to be attached to the housing understructure 230. The electrical power source 300 and the electrical connects 310 are attached to the abutment unit 290. The electrical circuitry 320 is attached to the abutment unit 290, in which the electrical circuitry 320 coupled to the electrical power source 300 and coupled to the electrical connects 310, wherein the electrical connects 310 are configured to be coupled to the electrodes 240 when the abutment unit 290 is attached to the housing understructure 230, whereby the electrical circuitry 320 is configured to be coupled to the electrodes 240 when the abutment unit 290 is attached to the housing understructure 230. The cosmetic dental prosthesis 190 is configured to be attached to the abutment unit 290. Finally, the insertion tool 160 is configured to hold the abutment unit 290.

One preferred embodiment of the method of installing an artificial tooth 10 into a jawbone 200 comprises the steps of: cementing, combining, cutting, extricating, installing, joining, linking, obtaining, opening, reaming, releasing, removing, sewing, and testing. The obtaining step comprises obtaining a dental implant kit 220 comprising: a housing understructure 202; at least two opposing electrodes 240 attached to the housing understructure 202; a closure unit 250 configured to be attached to the housing understructure 202; an electrical power supply 260 attached to the closure unit 206; at least two electrical contacts 270 attached to the closure unit 206; an electrical circuit 280 attached to the closure unit 250, the electrical circuit 280 coupled to the electrical power supply 260 and coupled to the electrical contacts 270, wherein the electrical contacts 270 are configured to be coupled to the electrodes 240 when the closure unit 250 is attached to the housing understructure 230, whereby the electrical circuit 280 is configured to be coupled to the electrodes 240 when the closure unit 250 is attached to the housing understructure 202; an abutment unit 290 configured to be attached to the housing understructure 202; an electrical power source 300 attached to the abutment unit 216; at least two electrical connects 310 attached to the abutment unit 216; an electrical circuitry 320 attached to the abutment unit 290, the electrical circuitry 320 coupled to the electrical power source 300 and coupled to the electrical connects 310, wherein the electrical connects 310 are configured to be coupled to the electrodes 240 when the abutment unit 290 is attached to the housing understructure 230, whereby the electrical circuitry 320 is configured to be coupled to the electrodes 240 when the abutment unit 290 is attached to the housing understructure 202; a cosmetic dental prosthesis 190 configured to be attached to the abutment unit 216; and an insertion tool 160 configured to hold the abutment unit 290. The cutting step comprises cutting into gum 130 tissue overlaying a remnant of a natural tooth 10. The step comprises extricating any remnant of the natural tooth 10 from the jawbone 200. The reaming step comprises reaming a cavity 340 in the jawbone 200 where the natural tooth 10 was extricated. The combining step comprises combining together the closure unit 250 to the housing understructure 230. The testing step comprises testing the electrodes 240 for electrical functionality of the combined closure unit 250 housing understructure 230. The installing step comprises installing the combined closure unit 250 housing understructure 230 into the cavity 340 in the jawbone 200. The sewing step comprises sewing the cut gum 130 tissue over the combined closure unit 250 housing understructure 230. The opening step comprises opening up gum 130 tissue overlaying the combined closure unit 250 housing understructure 230. The removing step comprises removing the closure unit 250 from housing understructure 230 while leaving the housing understructure 230 installed in the jawbone 200. The linking step comprises linking together the insertion tool 160 to the abutment unit 290. The joining step comprises joining together the abutment unit 290 with the housing understructure 230 when the housing understructure 230 is installed in the jawbone 200. The releasing step comprises releasing the abutment unit 290 from the insertion tool 160 when the abutment unit 290 is joined together with the housing understructure 230 when the housing understructure 230 is installed in the jawbone 200. The cementing step comprises cementing the cosmetic dental prosthesis 190 to the abutment unit 290.

Even though the preferred embodiments of the kit 220 and the associated method of using the kit 220 are labeled as a dental implants and are illustrated to be installed into a jawbone, other kit and method embodiments are envisioned to generally serve as to couple mechanically percutaneous prosthetic members for attachment of artificial eyes, noses, ears, limbs, and in particular, teeth to bone.

Referring now to FIG. 4 which depicts a conventional prior art endosteal implant system 140 comprising an implant 150, an insertion tool 160, a closure shank 170, and an abutment adaptor 180 adapted to receive a dental prosthesis 190.

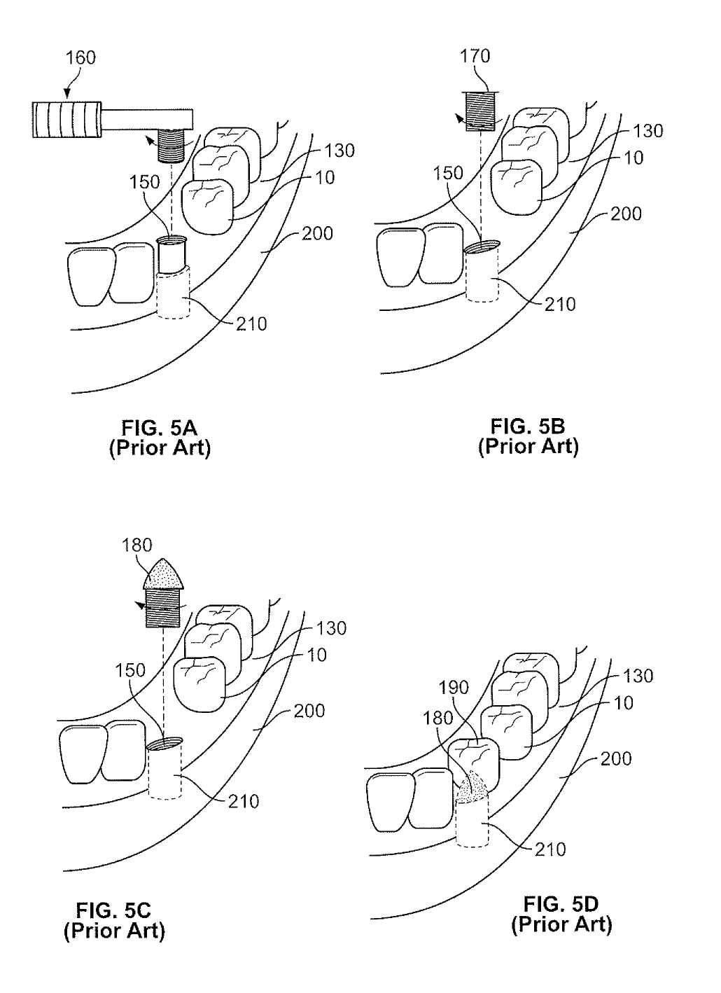

Referring now to FIG. 5A-5D which depict schematic perspective views of a lower human jawbone illustrating the use of components of the prior art system shown in FIG. 4. As shown in FIG. 5A, the implant 150 is then inserted into a prepared hole 210 (represented by phantom lines in FIGS. 5A-5D) within the jawbone 200 by using the insertion tool 160 to screw (represented by arrow in FIG. 5A) the implant 150 into the jawbone 200 (e.g., with the aid of a ratchet). The inserted implant 150 is shown in FIG. 5B. Next, as also shown in FIG. 5B, the closure shank 170 is then screwed (represented by arrow in FIG. 5B) into the top portion of the implant 150. The first part of the procedure is then complete. The second part of the procedure is performed desirably at least several weeks later. This waiting period permits time for osteo (bone) ingrowth into the implant 150. This process however does not reestablish the periodontal membrane/ligament that was destroyed as a result of the tooth loss. The contact between the implant and the bone is a rigid connection with no dampening effect. After the appropriate waiting period, the second part of the procedure is then performed. First, the closure shank 170 is removed (not shown). Second, as illustrated in FIG. 5C, the abutment adaptor 180 is screwed (represented by arrow in FIG. 5C) into the top portion of the implant 150. Finally, as shown in FIG. 5D, a conventional dental prosthesis 190 is attached to the abutment adaptor 180 using conventional techniques.

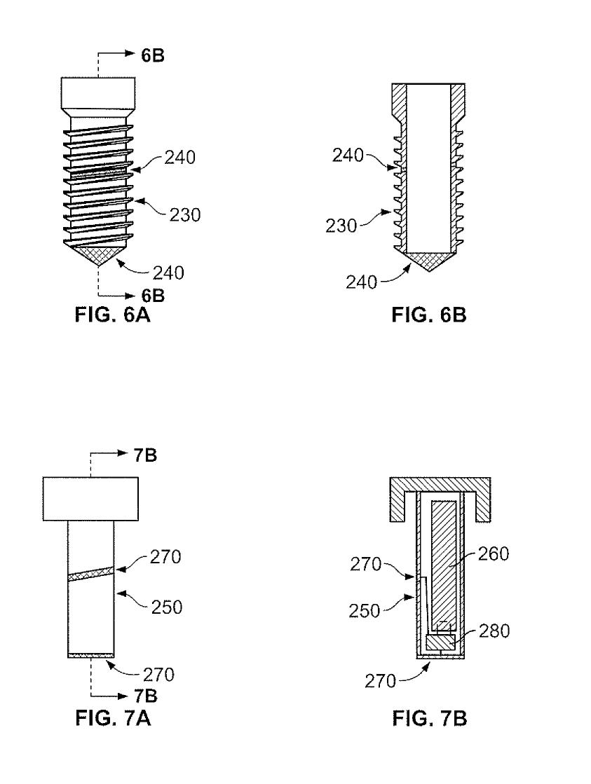

Referring now to FIG. 6A-6B which illustrate a side view and a respective cross sectional side view of an embodiment of the housing understructure 230 of the dental implant kit 220. The housing understructure 230 is shown having two electrodes 240 which are electrically insulated from one another.

Referring now to FIG. 7A-7B which depict a side view and a respective cross sectional side view of an embodiment of the closure unit 250 of the dental implant kit 220. The closure unit 250 is shown having two attached electrical contacts 270 in which the two electrical contacts 270 are shown coupled to an electrical circuit 280. The electrical circuit 280 is also shown coupled to an electrical power supply 260. The electrical circuit 280 and the electrical power supply 260 are shown hermetically sealed within the closure unit 250.

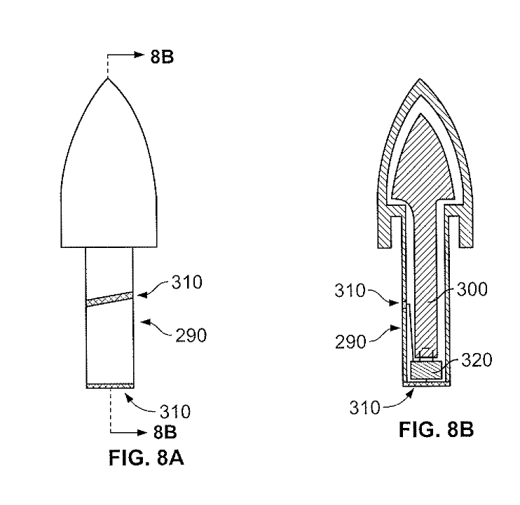

Referring now to FIG. 8A-8B which depict are a side view and a respective cross sectional side view of an embodiment of the abutment unit 290 of the dental implant kit 220. The abutment unit 290 is shown having two attached electrical connects 310 in which the electrical connects 310 are shown coupled to an electrical circuitry 320. The electrical circuitry 320 is also shown coupled to an electrical power source 300. The electrical circuitry 320 and the electrical power source 300 are shown hermetically sealed within the abutment unit 290.

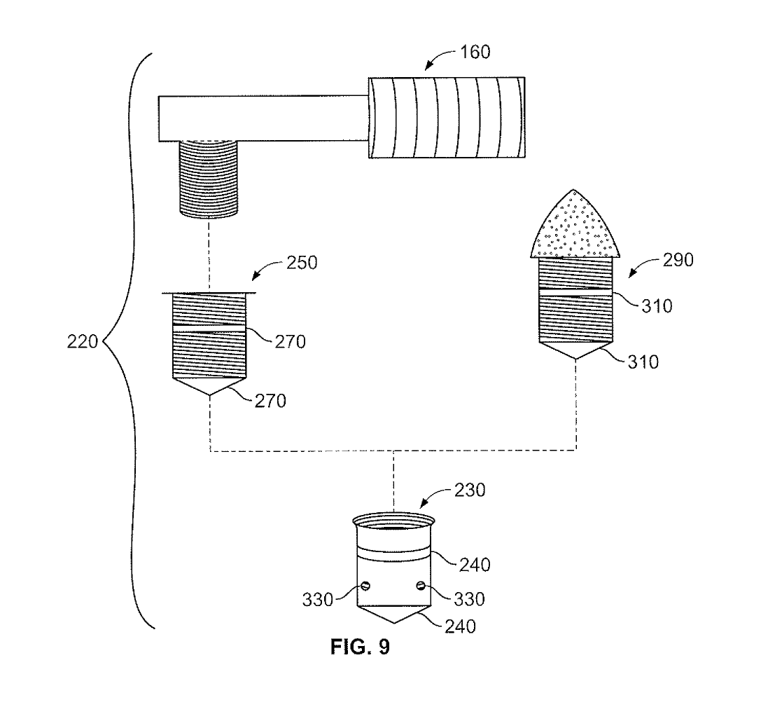

Referring now to FIG. 9 which illustrates an exploded perspective view of a dental implant kit 220 of the present invention. The dental implant kit 220 is shown comprising a housing understructure 230 having at least two opposing electrodes 240 attached to it; a closure unit 250 having at least two electrical contacts 270 attached to it; an abutment unit 290 having at least two electrical connects 310 attached to it; and an insertion tool 160.

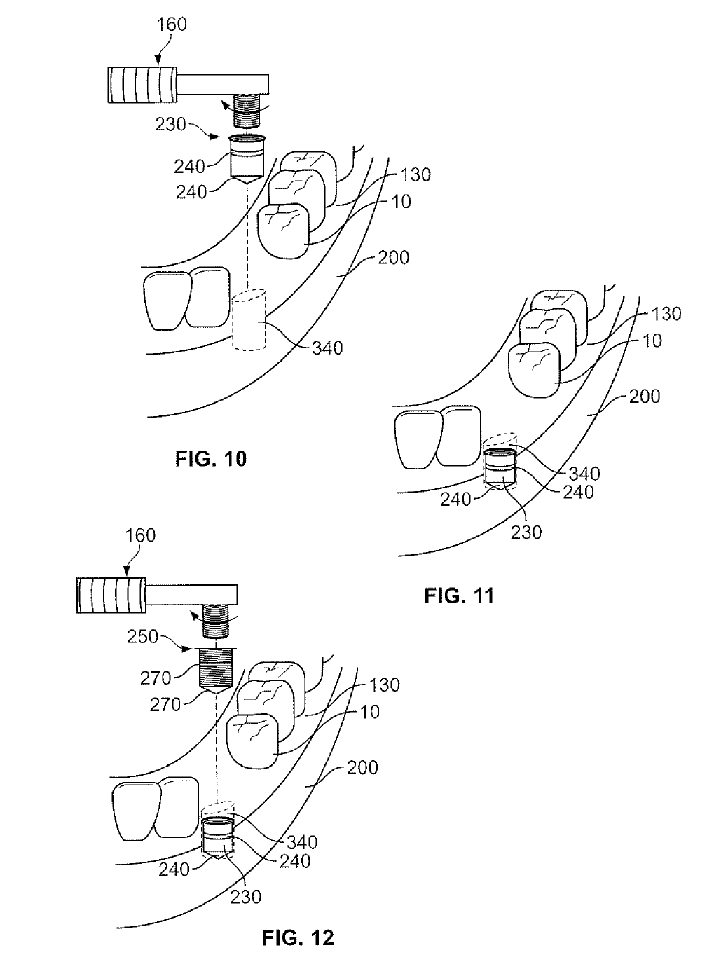

Referring now to FIG. 10 which depicts a stylized side perspective view of a portion of a lower human jawbone 200 showing the insertion of the housing understructure 230 into a reamed out cavity 340 in the jawbone 200. As seen in FIG. 10, the housing understructure 230 is inserted (depicted by dot-dash line ill FIG. 10) into the prepared cavity 340 in the jawbone 200.

FIG. 11 depicts the housing understructure 230 mounted within the jawbone 200 in which the two electrodes 240 are shown buried deep within the jawbone 200 for the eventual use in accelerating the healing of the jawbone 200 and housing understructure 230 interface.

FIG. 12 depicts the closure unit 250 being attached (depicted by dot-dash line in FIG. 12) into the housing understructure 230 into the housing understructure 230 mounted within the jawbone 200. When the closure unit 250 is attached to the housing understructure 250 (not shown), the electrical contacts 270 of the closure unit 250 are configured to be coupled to the electrodes 240. The electrical circuit 280 (not shown) of the closure unit 250 is also configured to be coupled to the electrodes 240 when the closure unit 250 is attached to the housing understructure 230 (not shown). Accordingly, the attached closure unit 250 containing the electrical power supply 260 (not shown) can then provide the requisite electrical energy to activate the two electrodes 240 of the housing understructure 230 to accelerating the time needed to heal the interface at the Jawbone 200 and housing understructure 230. In the event that the interface of the jawbone 200 and the housing understructure 230 has not healed sufficiently then replacement closure unit 250 (not shown) may be mounted within the housing understructure 230. In the event that the interface of the jawbone 200 and the housing understructure 230 has healed sufficiently then the closure unit 250 may be removed from the housing understructure 230 while leaving the housing understructure 230 healed within the jawbone 200.

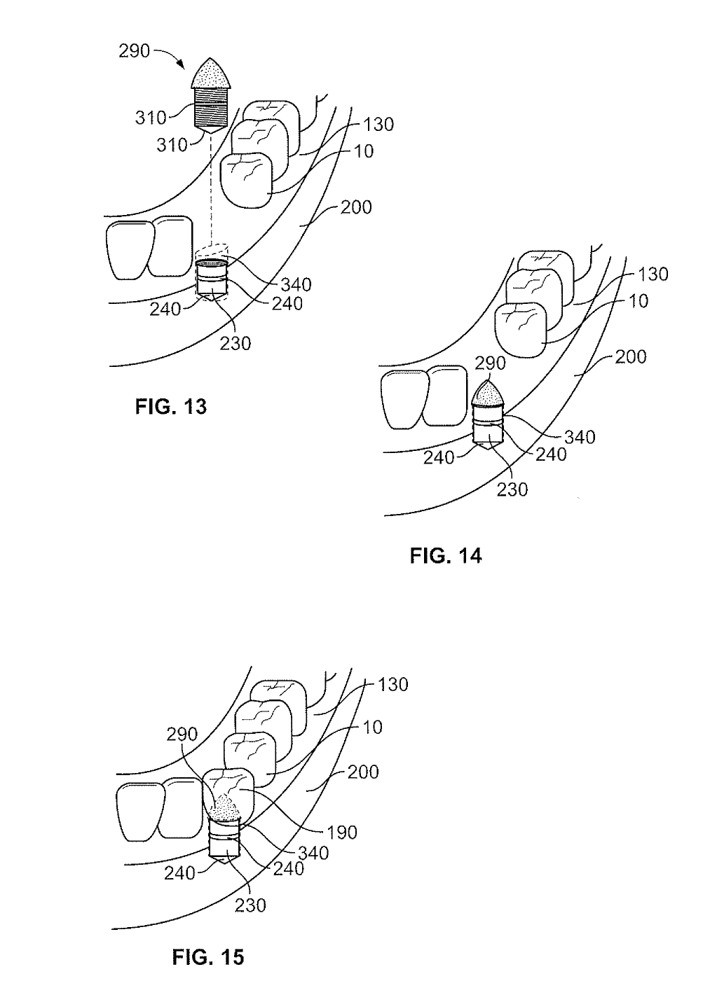

FIG. 13 depicts is the abutment unit 290 being inserted (depicted by dot-dash line in FIG. 14) into the housing understructure 230. The two electrical connects 240 are shown attached to the abutment unit 290.

FIG. 14 depicts the abutment unit 290 inserted into the housing understructure 230 which was previously been mounted within the jawbone 200. Since the electrical connects 240 (not shown) of the abutment unit 290 are configured to be coupled to the electrodes 240 when the abutment unit 290 is attached to the housing understructure 230 then the electrical circuitry 320 (not shown) of the abutment unit 290 is also configured to be coupled to the electrodes 240 when the abutment unit 290 is attached to the housing understructure 230. Accordingly, the attached abutment unit 290 containing the electrical power source 300 (not shown) can then provide the requisite electrical energy to activate the two electrodes 240 of the housing understructure 230 to further accelerate the time needed to heal the jawbone 200 and housing understructure 230 interface. It is also envisioned that the attached abutment unit 290 containing the electrical power source 300 (not shown) can also be used to provide the requisite electrical energy to activate the two electrodes 240 of the housing understructure 230 to provide a means for promoting the health (i.e., preventive maintenance) of the housing understructure 230 and jawbone 200 interface by encouraging the repair of any consequential damage brought about by long term wear.

FIG. 15 depicts a dental prosthesis 190 cemented onto a portion of the abutment unit 290 when the abutment unit 290 is inserted into the housing understructure 230 mounted within the jawbone 200.

As to the manner of usage and operation of the present invention, the same should be apparent from the above description. Accordingly, no further discussion relating to the manner of usage and operation will be provided.

While a preferred embodiment of the dental implant kit and method of using has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Throughout this specification, unless the context requires otherwise, the word “comprise” or variations such as “comprises” or “comprising” or the term “includes” or variations, thereof, or the term “having” or variations, thereof will be understood to imply the inclusion of a stated element or integer or group of elements or integers but not the exclusion of any other element or integer or group of elements or integers. In this regard, in construing the claim scope, an embodiment where one or more features is added to any of the claims is to be regarded as within the scope of the invention given that the essential features of the invention as claimed are included in such an embodiment.

Those skilled in the art will appreciate that the invention described herein is susceptible to variations and modifications other than those specifically described. It is to be understood that the invention includes all such variations and modification which fall within its spirit and scope.

The invention also includes all of the steps, features, compositions and compounds referred to or indicated in this specification, individually or collectively, and any and all combinations of any two or more of said steps or features.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention,

We claim:

1. A dental implant kit comprising:
a housing understructure;
at least two opposing electrodes attached to the housing understructure; and
a closure unit configured to be attached to the housing understructure;
an electrical power supply attached to the closure unit;
at least two electrical contacts attached to the closure unit; and
an electrical circuit attached to the closure unit, the electrical circuit coupled to the electrical power supply and coupled to the electrical contacts,
wherein the electrical contacts are configured to be coupled to the electrodes when the closure unit is attached to the housing understructure,
whereby the electrical circuit is configured to be coupled to the electrodes when the closure unit is attached to the housing understructure.

2. The kit of claim 1 further comprising a cosmetic dental prosthesis configured to be attached to the closure unit.

3. The kit of claim 1 further comprising an abutment unit configured to be attached to the housing understructure.

4. The kit of claim 3 further comprising:
an electrical power source attached to the abutment unit;
at least two electrical connects attached to the abutment unit; and
an electrical circuitry attached to the abutment unit, the electrical circuitry coupled to the electrical power source and coupled to the electrical connects,
wherein the electrical connects are configured to be coupled to the electrodes when the abutment unit is attached to the housing understructure,
whereby the electrical circuitry is configured to be coupled to the electrodes when the abutment unit is attached to the housing understructure.

5. The kit of claim 3 further comprising a cosmetic dental prosthesis configured to be attached to the abutment unit.

6. The kit of claim 1 further comprising an inserting device configured to hold the abutment unit.

7. The kit of claim 1 wherein the electrodes are electrically isolated from the housing understructure.

8. The kit of claim 1 wherein the electrical power supply and the electrical circuit are hermetically sealed within the closure unit.

9. The kit of claim 4 wherein the electrical power source and the electrical circuitry are hermetically sealed within the abutment unit.

10. The kit of claim 1 wherein the electrical circuit configured to control an electrical current applied across the two electrodes when the closure unit is attached to the housing understructure.

11. The kit of claim 10 wherein the electrical current applied across the two electrodes is no more than 20 milliamps.

12. The kit of claim 4 wherein the electrical circuitry configured to control an electrical current applied across the two electrodes when the abutment unit is attached to the housing understructure.

13. The kit of claim 12 wherein the electrical current applied across the two electrodes is no more than 20 milliamps.

14. The kit of claim 1 wherein the electrical circuit configured to control an electrical voltage applied across the two electrodes when the closure unit is attached to the housing understructure.

15. The kit of claim 4 wherein the electrical circuitry configured to control an electrical voltage applied across the two electrodes when the abutments unit is attached to the housing understructure.

16. The kit of claim 1 wherein the housing understructure having a plurality of pores in the housing understructure.

17. The kit of claim 1 wherein the electrical power supply is selected from the group consisting of a battery power supply and a high capacity capacitor power supply.

18. The kit of claim 4 wherein the electrical power source is selected from the group consisting of a battery power source and a high capacity capacitor power source.

19. A dental implant kit comprising:
a housing understructure;
at least two opposing electrodes attached to the housing understructure;
a closure unit configured to be attached to the housing understructure;
an electrical power supply attached to the closure unit;
at least two electrical contacts attached to the closure unit;
an electrical circuit attached to the closure unit, the electrical circuit coupled to the electrical power supply and coupled to the electrical contacts,
wherein the electrical contacts are configured to be coupled to the electrodes when the closure unit is attached to the housing understructure,
whereby the electrical circuit is configured to be coupled to the electrodes when the closure unit is attached to the housing understructure;
an abutment unit configured to be attached to the housing understructure;
an electrical power source attached to the abutment unit;
at least two electrical connects attached to the abutment unit;
an electrical circuitry attached to the abutment unit, the electrical circuitry coupled to the electrical power source and coupled to the electrical connects,
wherein the electrical connects are configured to be coupled to the electrodes when the abutment unit is attached to the housing understructure,
whereby the electrical circuitry is configured to be coupled to the electrodes when the abutment unit is attached to the housing understructure;
a cosmetic dental prosthesis configured to be attached to the abutment unit; and
an inserting device configured to hold the abutment unit.

20. A method of installing an artificial tooth into a jawbone, the method comprising the steps of obtaining a dental implant kit comprising:
a housing understructure;
at least two opposing electrodes attached to the housing understructure;
a closure unit configured to be attached to the housing understructure;
an electrical power supply attached to the closure unit;
at least two electrical contacts attached to the closure unit;
an electrical circuit attached to the closure unit, the electrical circuit coupled to the electrical power supply and coupled to the electrical contacts,
wherein the electrical contacts are configured to be coupled to the electrodes when the closure unit is attached to the housing understructure,
whereby the electrical circuit is configured to be coupled to the electrodes when the closure unit is attached to the housing understructure;
an abutment unit configured to be attached to the housing understructure;
an electrical power source attached to the abutment unit;
at least two electrical connects attached to the abutment unit;
an electrical circuitry attached to the abutment unit, the electrical circuitry coupled to the electrical power source and coupled to the electrical connects,
wherein the electrical connects are configured to be coupled to the electrodes when the abutment unit is attached to the housing understructure,
whereby the electrical circuitry is configured to be coupled to the electrodes when the abutment unit is attached to the housing understructure;
a cosmetic dental prosthesis configured to be attached to the abutment unit; and
an inserting device configured to hold the abutment unit;
cutting into gum tissue overlaying a remnant of a natural tooth;
extricating any remnant of the natural tooth from the jawbone;
reaming a cavity in the jawbone where the natural tooth was extricated;
combining together the closure unit to the housing understructure;
testing the electrodes for electrical functionality of the combined closure unit housing understructure;
installing the combined closure unit housing understructure into the cavity in the jawbone;
sewing the cut gum tissue over the combined closure unit housing understructure;
opening up gum tissue overlaying the combined closure unit housing understructure;
removing the closure unit from housing understructure while leaving the housing understructure installed in the jawbone;
linking together the inserting device to the abutment unit;
joining together the abutment unit with the housing understructure when the housing understructure is installed in the jawbone;
releasing the abutment unit from the inserting device when the abutment unit is joined together with the housing understructure when the housing understructure is installed in the jawbone; and cementing the cosmetic dental prosthesis to the abutment unit.
